(19) United States
(12) Patent Application Publication
(10) Pub. No.: US 2026/0312858 A1
(43) Pub. Date: Oct. 8, 2026

(54) METHODS FOR CYCLIC PREFIX HANDLING FOR LOW-POWER RECEIVERS

(71) Applicant: Telefonaktiebolaget LM Ericsson (publ), Stockholm (SE)

(72) Inventors: Mohammad MOZAFFARI, FREMONT, CA (US); Kittipong KITTICHOKECHAI, JarfaIla (SE); Ajit NIMBALKER, DUBLIN, CA (US)

(21) Appl. No.: 19/483,352

(22) PCT Filed: May 8, 2024
(86) PCT No.: PCT/SE2024/050437

§ 371 Date: Nov. 11, 2025

Related U.S. Application Data
(60) Provisional application No. 63/466,135, filed on May 12, 2023.

(51) Int. Cl. H04L 27/26; H04L 27/04

(52) U.S. Cl. CPC H04L 27/2678; H04L 27/04; H04L 27/26025

(57) ABSTRACT

Method and user equipment for handling a cyclic prefix for an on-off keying, OOK, signal transmitted by an orthogonal frequency-division multiplexing, OFDM, transmitter One aspect of the invention provides a method performed by a user equipment. The method comprises receiving a signal comprising a cyclic prefix and an OOK signal and discarding or using the cyclic prefix in the received signal to detect the OOK signal.

### TECHNICAL FIELD

The present disclosure relates to wireless communications, and in particular, to methods for handling cyclic prefix for low-power receivers.

### BACKGROUND

A ‘wake-up signal’ (WUS) is based on the transmission of a short signal that indicates to the user equipment (UE) that it should continue to decode the downlink (DL) control channel e.g. full NPDCCH (Narrowband Physical Downlink Control Channel) for narrowband internet of things (NB-IoT). If such signal is absent (discontinuous transmission (DTX) i.e., UE does not detect it) then the UE can go back to sleep without decoding the DL control channel. The decoding time for a WUS is considerably shorter than that of the full NPDCCH since it essentially only needs to contain one bit of information whereas the NPDCCH may contain up to 35 bits of information. This, in turn, reduces UE power consumption and leads to longer UE battery life. The WUS would be transmitted only when there is a paging for the UE. But if there is no paging for the UE then the WUS will not be transmitted (i.e., implying a discontinuous transmission) and the UE would go back to deep sleep e.g., upon detecting DTX instead of WUS. This is illustrated in FIG. 1, where white blocks indicate possible WUS and paging occasion (PO) positions whereas the black boxes indicate actual WUS and PO positions. A WUS can be relatively shorter and require less reception time for UE than a coverage enhancement physical downlink control channel (PDCCH), which may be repeated many times. Thus, a UE can check for a WUS a certain time before its PO, and only if a WUS is detected would continue to check for PDCCH in the PO, and if not, which would be most of the time, the UE can go back to a sleep state to conserve energy. Thus, the WUS can be of variable length depending on the UE's coverage, as shown in FIG. 3.

In general, there are two approaches for detecting wake-up signals such as described above: using the main receiver and having a dedicated wake-up receiver or wake-up radio (WUR). When using the first of these approaches, there is no need for additional dedicated hardware for monitoring WUS, and the coverage of the main receiver is typically not impacted. However, this may require higher power usage than when a WUR is used. When using the second approach, there can be a low power, simple and low-cost receiver architecture, a noisier (i.e., less accurate) clock or oscillator may be used, and there may be relaxed power requirements. Additionally, there can be power savings achieved by maximizing the time in which the main receiver can be in sleep mode, and this can be an enabler for zero energy/battery-less devices, and energy harvesting operations. However, there may be coverage considerations associated with trading off WUR power consumption and sensitivity.

Considering specifically approaches to detecting WUS using a dedicated wake-up receiver, in case of the detection of a wake-up signal, the WUR may wake up the main (baseband/radiofrequency (RF)/less power efficient) receiver to detect an incoming message. This may be a paging message, such as a physical downlink control channel on a paging occasion scheduling a paging message on a physical downlink shared channel (PDSCH). This may provide a benefit of employing WUR in lowering energy consumption and allowing longer device battery life, or at a fixed energy consumption the downlink latency may be reduced (shorter discontinuous reception (DRX)/duty-cycles and more frequent checks for incoming transmissions). To illustrate, FIG. 2 shows a dedicated wake up radio is used for monitoring a wake-up signal. Once WUR detects the intended WUS, it wakes up the main (baseband/RF/less power efficient) receiver to detect further incoming messages. Therefore, the main receiver can go to sleep mode and save power until it is triggered by WUR. In this case, the WUR may be an ultra-low power and low-complexity receiver which can support simple modulation schemes such as on-off keying (OOK), frequency-shift keying (FSK), or phase-shift keying (PSK).

In the Third Generation partnership project (3GPP) release 17 (Rel-17), discussions started on introducing a WUS for New Radio (NR), then called ‘Paging Early Indication’ (PEI). However, since at the time no coverage enhancement was specified for NR, the only gain for Rel-17 PEI was for scenarios where the small fraction of UEs are in bad coverage and with large synchronization error due to the use of longer cycles. The gain for such UEs was that with the use of PEI they would typically only have to acquire one synchronization signal block (SSB) before decoding PEI, instead of up to 3 SSBs if PEI is not used (value according to UE vendors). So, for most UEs, Rel-17 PEI will result in gains or increased performance. However, it was also agreed that PEI would be physical downlink control channel based, making it much less interesting for dedicated wake up receivers (wake up receivers, or WURs), because the main baseband receiver would be used for decoding PEI.

In 3GPP release 18 (Rel-18), there has been rather large interest in introducing WUR for NR, with an ambition for achieving more significant energy efficiency improvement compared to solutions already specified in earlier releases. The only specification support needed to be able to use a WUR in the UE, is the specification of a WUS and a long enough time gap between the WUS and the PDCCH in the PO (to allow the UE to start up the main receiver). Therefore, the main difference to Rel-17 PEI is the WUS in Rel-18 should not be PDCCH-based and allow for a simpler and low power receiver, i.e. WUR with simple modulation and detection techniques (e.g. using on-off keying, modulation and non-coherent detection).

In Rel-18, a study item on “low-power wake-up signal and receiver for NR” was approved. The justification section of that study item stated that 5G systems are designed and developed targeting for both mobile telephony and vertical use cases. Besides latency, reliability, and availability, UE energy efficiency is also critical to 5G. Currently, 5G devices may have to be recharged per week or day, depending on individual's usage time. In general, 5G devices consume tens of milliwatts in radio resource control (RRC) idle/inactive state and hundreds of milliwatts in RRC connected state. Designs to prolong battery life is a necessity for improving energy efficiency as well as for better user experience.

The justification continued that energy efficiency is even more critical for UEs without a continuous energy source, e.g., UEs using small rechargeable and single coin cell batteries. Among vertical use cases, sensors and actuators are deployed extensively for monitoring, measuring, charging, etc. Generally, their batteries are not rechargeable and expected to last at least few years as described in technical report (TR) 38.875. Wearables include smart watches, rings, eHealth related devices, and medical monitoring devices. With typical battery capacity, it is challenging to sustain up to 1-2 weeks as required.

The justification section further explained that the power consumption depends on the configured length of wake-up periods, e.g., paging cycle. To meet the battery life requirements above, extended discontinuous reception (eDRX) cycle with large value is expected to be used, resulting in high latency, which is not suitable for such services with requirements of both long battery life and low latency. For example, in fire detection and extinguishment use case, fire shutters shall be closed and fire sprinklers shall be turned on by the actuators within 1 to 2 seconds from the time the fire is detected by sensors, long eDRX cycle cannot meet the delay requirements. eDRX is apparently not suitable for latency-critical use cases. Thus, the intention is to study ultra-low power mechanism that can support low latency in Rel-18, e.g. lower than eDRX latency.

The justification section concluded that currently, UEs need to periodically wake up once per DRX cycle, which dominates the power consumption in periods with no signalling or data traffic. If UEs are able to wake up only when they are triggered, e.g., paging, power consumption could be dramatically reduced. This can be achieved by using a wake-up signal to trigger the main radio and a separate receiver which has the ability to monitor wake-up signal with ultra-low power consumption. Main radio works for data transmission and reception, which can be turned off or set to deep sleep unless it is turned on. The power consumption for monitoring wake-up signal depends on the wake-up signal design and the hardware module of the wake-up receiver used for signal detecting and processing. The study should primarily target low-power WUS/WUR for power-sensitive, small form-factor devices including internet of things (IoT) use cases (such as industrial sensors, controllers) and wearables. Other use cases are not precluded, e.g., extended reality (XR)/smart glasses, smart phones.

In light of that justification, the study item's objectives section stated: as opposed to the work on UE power savings in previous releases, this study will not require existing signals to be used as WUS. All WUS solutions identified shall be able to operate in a cell supporting legacy UEs. Solutions should target substantial gains compared to the existing Rel-15/16/17 UE power saving mechanisms. Other aspects such as detection performance, coverage, UE complexity, should be covered by the evaluation. It then laid out the following objectives:
Identify evaluation methodology (including the use cases) & key performance indicators (KPIs)
   Primarily target low-power WUS/WUR for power-sensitive, small form-factor devices including IoT use cases (such as industrial sensors, controllers) and wearables
      Other use cases are not precluded
Study and evaluate low-power wake-up receiver architectures
Study and evaluate wake-up signal designs to support wake-up receivers
Study and evaluate physical layer (L1) procedures and higher layer protocol changes needed to support the wake-up signals
Study potential UE power saving gains compared to the existing Rel-15/16/17 UE power saving mechanisms and their coverage availability, as well as latency impact. System impact, such as network power consumption, coexistence with non-low-power-WUR UEs, network coverage/capacity/resource overhead should be included in the study.

The institute of electrical and electronics engineers (IEEE) also standardized support for WUR. Similar to the 3GPP solution, the use of WUR is only enabled in stations and not in access points (APs), that is for downlink communication only. The AP advertises that it has WUR operation capability, along with WUR configuration parameters (among other info, in which band/channel WUR is operational, which can be different from the band/channel used for data transmission using the main receiver, e.g. WUR in 2.4 GHz band but data communication in 5 gigahertz (GHz) band. Also note that the WUR operating channel is advertised in the beacon, and that the WUR discovery operating channel may be different from the WUR operating channel.). Stations can then request to be configured with WUR mode of operation. This request has to be granted by the AP, and in case it is granted, the station is further configured/setup for WUR mode of operation (the configuration is only valid for the connection to the associated AP, and further the configuration must be torn down/de-configured if WUR is not used anymore). Both continuous WUR (receiver open all the time) and duty-cycled WUR (receiver only open during preconfigured time slots) mode of operations are supported. For the latter the length of the duty-cycles and on-time during wake up is part of the WUR configuration.

Unlike the 3GPP solution, the WUR operation mode is a “sub-state” of the regular operation and upon the detection of a WUS transmission from the AP, the station will resume the power saving mechanism it was configured with before entering the WUR operation mode. That is, IEEE has specified a number of different power saving mechanisms, and for example if duty-cycled monitoring of the downlink has been configured for the station it will switch to that upon detection of the WUS (i.e. unlike the specified 3GPP mechanism which only covers paging, and the UE will continue to monitor PDCCH if WUS is detected). In this way the IEEE WUR functionality is more general, and still allows for the station to upon detection of WUS “monitor paging” by checking in the beacon from the AP for which stations there is data, or for the station to directly respond with an uplink transmission.

The physical wake-up signal in IEEE contains complete frames which must be processed by the station. The IEEE WUS contains information to indicate if the WUS is a WUR sync beacon, a WUR discovery beacon, or a regular WUS (intended to wake the station up). The WUS can also contain proprietary frames, which could e.g. be used to directly turn actuators on/off. The transmission uses on/off keying modulation, using Manchester coding, but is using multi-carrier OOK which can be generated by an orthogonal frequency-division multiplexing (OFDM) transmitter (i.e. WUR can be enabled as a software upgrade in APs). The WUS is 4 MHz wide, but a whole 20 MHz channel is reserved. The WUS starts with a 20 MHz legacy preamble (to allows other stations to perform carrier sense) followed by 4 MHz Manchester coded OOK. Two data rates are supported: 62.5 kbps and 250 kbps, and link adaptation is up to the AP (each packet is self-contained and includes the data rate, i.e. in the WUR there are two possible sync words used to signal the data rate).

NR employs the cyclic prefix (CP) OFDM scheme in downlink and uplink and discrete Fourier transform (DFT) spread OFDM (DFT-s-OFDM) in uplink. The CP provides a guard interval to reduce inter-symbol interference from the previous symbols, thus improving the link reliability in multipath environments. Specifically, CP is created by replicating samples from the end of each OFDM symbol to the front of the symbol. In this way, the linear convolution of a frequency-selective multipath channel can be modeled as a circular convolution and subsequently transformed to the frequency domain via a discrete Fourier transform. The CP insertion also enables using a simple channel estimation and equalization. An example of an OFDM symbol with cyclic prefix is provided in FIG. 4.

NR supports a flexible OFDM numerology which makes it suitable for a wide range of frequencies and deployment scenarios. The subcarrier spacing (SCS) is scalable by 15 [KHz]×2^{μ}, where μ∈{0, 1, 2, . . . }. The slot length (and symbol duration) decreases by increasing the SCS. In NR, each slot with normal CP consists of 14 OFDM symbols and each subframe is 1 millisecond (ms). Therefore, the number of slots within a subframe is a function of the SCS. Table 1 shows the OFDM symbol duration for different SCSs.

TABLE 1
OFDM Symbol duration and normal
cyclic prefix for different SCSs.

| Numerology factor (μ) | 0 | 1 | 2 | 3 | 4 |
|---|---|---|---|---|---|
| Subcarrier spacing | 15 | 30 | 60 | 120 | 240 |
| (kilohertz (kHz)) | | | | | |
| OFDM symbol duration | 66.67 | 33.33 | 16.67 | 8.33 | 4.17 |
| (microsecond (μs)) | | | | | |
| CP duration (μs) | 4.69 | 2.34 | 1.17 | 0.57 | 0.29 |
| Symbol duration including CP | 71.35 | 35.68 | 17.84 | 8.92 | 4.46 |
| for regular symbols (μs) | | | | | |
| CP duration for long | 5.2 | 2.86 | 1.69 | 1.11 | 0.81 |
| symbols (μs) | | | | | |
| Symbol duration including | 71.87 | 36.19 | 18.36 | 9.44 | 4.99 |
| CP for long symbols (μs) | | | | | |

The existing 3GPP and IEEE systems are based on the orthogonal frequency division multiplexing modulation. For a typical OFDM system, on the transmitter side, the cyclic prefix is added to the beginning of each OFDM symbol to reduce the impact of inter-symbol interference (ISI). On the OFDM receiver side, the cyclic prefix is removed before demodulation of the signal.

There currently exist certain challenge(s). Low-complexity and low-power receivers do not generally support an OFDM modulation due its significant power consumption. In fact, they support simple modulation schemes such as on-off keying or frequency-shift keying based on signal energy detection which requires an ultra-low-complexity receiver architecture. Meanwhile, it is highly desired to reuse the OFDM-based transmitter while supporting low-power receivers in coexistence with regular OFDM-based receivers. One challenge is to generate a low power signal using an OFDM-based transmitter which can be received by a simple low-power receiver while maintaining orthogonality of OFDM-based transmissions (i.e., minimizing inter-subcarrier interference). In this case, one important problem is to properly handle the cyclic prefix on the transmitter and/or low-power receiver to prevent negative impacts on the detection performance. For example, for an OOK receiver performing time-domain detection, the cyclic prefix can have negative impacts on the detection performance.

These challenges may be particularly significant in the Zero-Energy (ZE) IoT, also known as Ambient IoT, context. Devices which would be used in ZE IoT may be designed to operate without the need for manual battery replacement or recharging by harvesting energy from the surrounding environment, resulting in low maintenance and long-lasting functionality. However, the small size, ultra-low cost, and battery-less nature of ZE IoT devices presents unique design challenges. For example, supporting ZE IoT devices requires significant reduction of power consumption and complexity by simplifying the radiofrequency chain and baseband architecture, reducing memory size, and eliminating unnecessary components. To achieve ultra-low power consumption, communication procedures between ZE IoT devices and access points (AP) may be designed as simply as possible. As a result orthogonal frequency division multiplexing may not be suitable for ZE IoT devices due to its high-power consumption requirements, and simpler waveforms such as OOK/FSK modulation offer a more promising option for enabling ultra-low complexity data transmission and reception. However, one of the key challenges in adopting these simpler waveforms is ensuring compatibility with existing OFDM-based architecture. A 3GPP study on Ambient IoT (3GPP TR 22.840) investigates the feasibility of a new IoT technology to open new markets within 3GPP systems, whose number of connections and/or device density can be orders of magnitude higher than existing 3GPP IoT technologies, and which can provide complexity and power consumption orders-of-magnitude lower than existing 3GPP low power wide area (LPWA) technologies such as NB-IoT and long term evolution machine type communication (LTE-MTC).

### SUMMARY

Certain aspects of the disclosure and their embodiments may provide solutions to these or other challenges. For example, given an OFDM-based transmitter and a low-power receiver supporting low-complexity modulation such as on-off keying, different solutions for handling the CP at the receiver and transmitter are presented.

A first aspect of the invention provides a method for handling a cyclic prefix for an on-off keying, OOK, signal transmitted by an orthogonal frequency-division multiplexing, OFDM, transmitter, performed by a user equipment. The method comprises receiving a signal comprising a cyclic prefix and an OOK signal and discarding or using the cyclic prefix in the received signal to detect the OOK signal.

A second aspect of the invention provides a user equipment for handling a cyclic prefix for an on-off keying, OOK, signal transmitted by an orthogonal frequency-division multiplexing, OFDM, transmitter. The user equipment is configured to, and/or comprising processing circuitry configured to receive a signal comprising a cyclic prefix and an OOK signal and discard or use the cyclic prefix in the received signal to detect the OOK signal.

Certain embodiments include:
Adaptively discarding or using the CP at the receiver based on various factors including:
   receiver architecture, UE capability, synchronization and timing error,
   sequence, payload, coverage condition, data rate (number of OOK bits in one OFDM symbol), WUS structure
   low-power signal structure, low-power signal duration
Adaptively excluding CP, zero-padding, CP power reduction, sequence/payload selection at the transmitter. Factors such as traffic characteristics (presence of other non-WUS transmissions) and receiver capabilities are also considered.

Certain embodiments may provide one or more of the following technical advantage(s):
1) Efficient waveform generation with an OFDM-based transmitter which can be received by a simple receiver while maintaining orthogonality of OFDM-based transmissions.
2) Enhancing detection performance for low-power receivers.
3) Ensuring efficient coexistence of low-power receivers and regular devices.
4) Ensuring minimum impacts on transmitters (e.g., network node, 5G base station (gNB)) for supporting low power receivers.
5) Ensuring simple and efficient implementation.
6) Efficient use of low power receivers to maximize energy efficiency while maintaining the coverage in various deployment scenarios.
   Solutions provided herein can be considered as a key enabler of battery-less (zero-energy) devices and energy harvesting operations towards 5G Advanced and 6G.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates WUS and paging occasion (PO) positions.

FIG. 2 shows a dedicated wake up radio used for monitoring a wake-up signal.

FIG. 3 shows that a WUS can be of variable length depending on the UE's coverage.

FIG. 4 shows an example of an OFDM symbol with cyclic prefix.

FIG. 5 shows a setup where an OFDM-transmitter can generate a desired time-domain modulation scheme such as OOK which can be detected by a simple receiver such as a low power wake-up radio.

FIG. 6 shows an example of 4-bit OOK within one OFDM symbol generated with an OFDM transmitter with a CP part, according to some embodiments.

FIG. 7 illustrate adding of the CP to the last samples of the received signal, according to some embodiments.

FIG. 8 illustrates an OOK sequence composed of nearby ON/OFF segments for indicating bits 0 and 1, according to some embodiments.

FIG. 9 illustrates an example method by a user equipment, according to some embodiments.

FIG. 10 illustrates an example method by a network node, according to some embodiments.

FIG. 11 shows an example of a communication system QQ100 in accordance with some embodiments.

FIG. 12 shows a UE QQ200 in accordance with some embodiments.

FIG. 13 shows a network node QQ300 in accordance with some embodiments.

FIG. 14 is a block diagram of a host QQ400, which may be an embodiment, in accordance with various aspects described herein, of the host QQ116 of FIG. 11.

FIG. 15 is a block diagram illustrating a virtualization environment QQ500 in which functions implemented by some embodiments may be virtualized.

FIG. 16 shows a communication diagram of a host QQ602 communicating via a network node QQ604 with a UE QQ606 over a partially wireless connection in accordance with some embodiments.

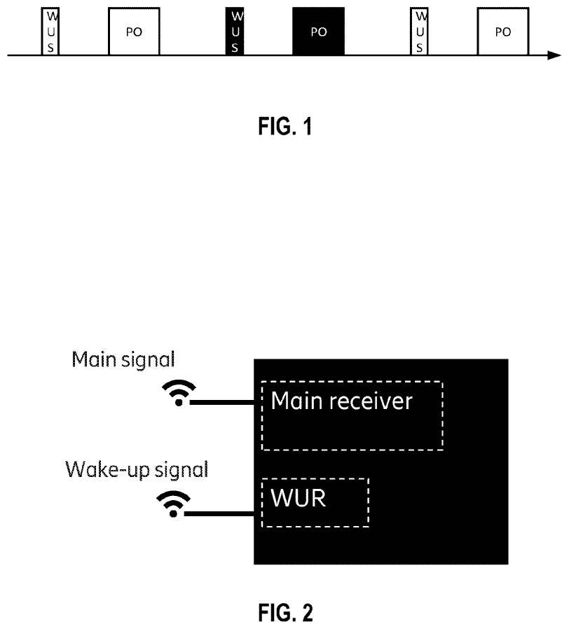

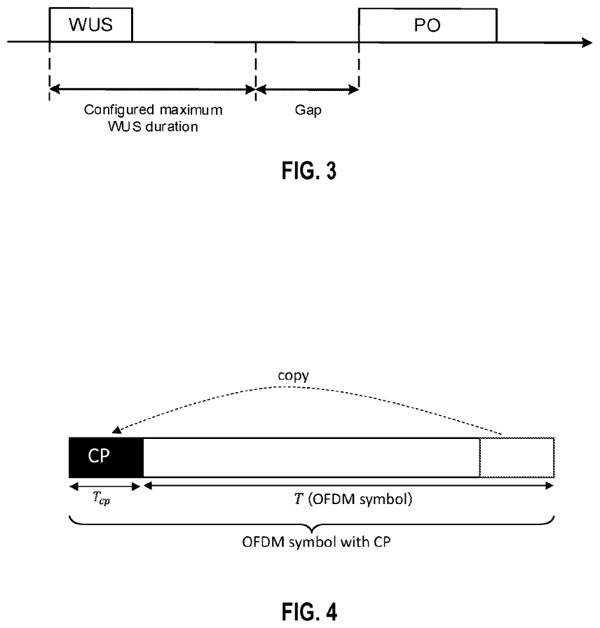

### DETAILED DESCRIPTION

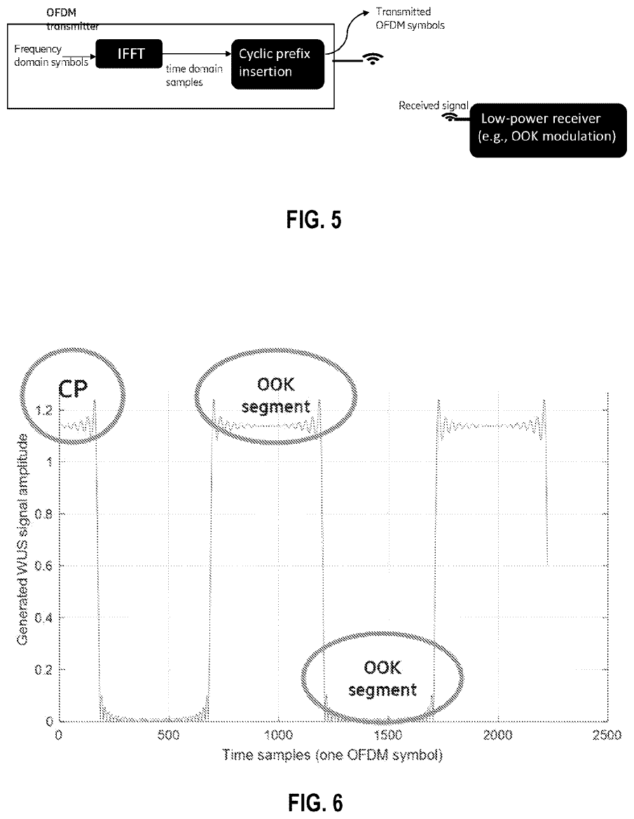

In a setup such as shown in FIG. 5, an OFDM-transmitter can generate a desired time-domain modulation scheme such as OOK which can be detected by a simple receiver such as a low power wake-up radio. The generated signal can be used for various purposes including a wake-up signal, reference signal for radio resource management (RRM) measurement, data transmissions, or any other indications. Here, WUS and WUR are referred to as examples of signal and low-power receiver. For modulation, as a non-limiting example, this discussion considers multi-bit OOK WUS (i.e., M-bit OOK) where multiple OOK bits (M bits) are transmitted within one OFDM symbol. FIG. 6 shows an example of 4-bit OOK within one OFDM symbol generated with an OFDM transmitter (OOK bits/segments are [0,1,0,1], and CP is included). The figure shows the CP part and OOK segments.

In general, the objective of enhancing the detection performance of a low-power receiving by efficiently handling the cyclic prefix can be advanced on the OFDM transmitter and/or low-power receiver based on various criteria.

Looking first at receiver side handling of the CP, in one type of embodiment, the receiver fully or partially skips (or deletes) the CP portion of the received signal based on several factors. These factors may include:
Level of synchronization (time and frequency error)
Clock error, receiver architecture
Sampling rate
Coverage condition
UE battery level
Modulation, coding, data rate
   For example, multi-bit OOK WUS (i.e., M-bit OOK) can be considered where multiple OOK bits (M bits) are transmitted within one OFDM symbol. In this case, M determines the data rate.
OFDM subcarrier spacing
WUS structure
   WUS structure can have any of preamble, sequence, or data parts
   CP handling approach can be different for different WUS parts
   CP handling method can be based on the WUS duration

In another type of embodiment, the receiver fully or partially uses the CP portion of the received signal based on conditions such as described above. For instance, the receiver uses K samples of the CP (with total CP length of L). Which K samples to use can be determined based on certain conditions/rules. Also, the mechanism for handling the CP at the receiver (e.g., whether to skip or use CP, and what portion to use) can be fixed (pre-configured), or may adaptively change based on the conditions. Some examples of this type of embodiment are provided below.

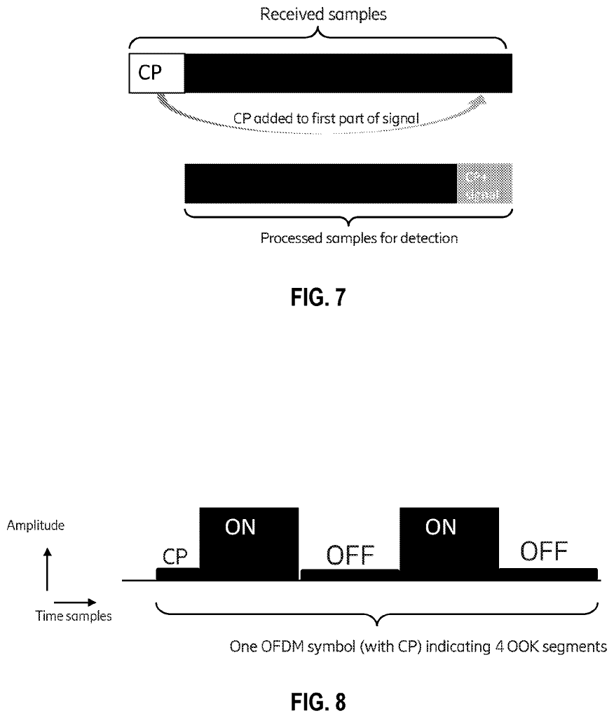

In an example, the receiver adds the CP part of the received signal to the last part of the received signal in each OFDM symbol while performing the detection. More specifically, as illustrated in FIG. 7, if the received signal has N samples: [x₁, . . . , x_{N}] per OFDM symbol, then the first L samples corresponding to the CP may be added to last L samples of the received signal, hence the new received signal after CP handling becomes [x_{L+1}, . . . , x_{N-L}, (x_{N-L+1}+x₁), (x_{N-L+2}+x₂), . . . , (x_{N}+x_{L})]. Compared to the case where CP is discarded, this approach can improve the detection performance by utilizing the energy of the CP part. Note that the gain of this approach depends on the time synchronization accuracy. For example, the maximum gain is attained in case of the perfect synchronization.

In another example, the CP is discarded if the timing error is greater than a certain threshold, otherwise, it is used (e.g., added to the last part of the received signal as discussed above). Also, the method of handling CP can depend on the timing error. For instance, this may use logic such as:
the CP is discarded if [timing error ≥X μs],
the CP is used based on approach 1 if [Y μs≤timing error <X μs]
the CP is used based on approach 2 if [timing error <Y μs]
   in the above logic, X and Y are certain thresholds for timing error. Approach 1 and approach 2 are two general examples of different methods of handling the CP. In one example, in approach 1 a portion of CP samples are used while in approach 2 the entire CP samples are used.

An OOK sequence is composed of nearby ON/OFF segments for indicating bits 0 and 1 (see FIG. 8). Detection is done by comparing the energy of ON segments with OFF segments. Depending on the OOK bits, in some cases it would be beneficial to utilize the CP part while in some other cases discarding the CP is preferred. For example, if the CP corresponds to bit 0 (i.e., OFF segment), then discarding CP reduces the noise and improves the detection performance.

In some embodiments of receiver side handling of the CP, CP is discarded if it corresponds to bit 0 (i.e., OFF segment in OOK sequence) which can be determined by estimating the energy of the segments at the receiver. For example, an OFF segment has considerably lower energy than an ON segment. Specifically, if the energy of the segment at the end of the OFDM symbol (i.e., right-most segment) is smaller than the average energy of the OFDM symbol, then the segment can be interpreted as 0 and CP is not used (i.e., is discarded). Otherwise, CP is used for improving the detection performance. In case that the pattern of ON/OFF segments of the OOK sequence is known to the receiver, the CP handling whether to discard or use can be applied directly based on the known sequence.

In general, the impact of CP becomes more important when the CP length is comparable with each OOK segment. For the M-bit OOK case, an OFDM symbol represents M OOK segments, and the duration of each segment is

$$\frac{{T}_{s}}{M} ,$$

where Tₛ is the OFDM symbol duration (without CP). As M increases, the duration of each segment becomes smaller, and it becomes closer to the CP duration. For example, for M≥8, the segment length is in the same order as the CP length.

In some embodiments of receiver side handling, the CP handling for M-bit OOK is based on the following conditions:
Receiver discards the CP if M≤X
Receiver uses the CP if M>X

In the above conditions, X is a threshold number of OOK segments within each OFDM symbol. Examples of such thresholds may be {4, 6, 8, 16}.

In another type of embodiment receiver side handling, the receiver adopts a hybrid approach for handling the CP. For example, in method 1 the CP is discarded and in method 2 the CP is used (based on any of the above descriptions). The receiver uses both methods, performs detection based on each method, and then compares the results. The receiver can use different approaches for interpreting these two sets of results. For example:
The detection result of the method with the higher confidence level is selected. The receiver can compute a detection metric for each method and compare them.
The detection result is based on an average of the two methods.

Another aspect is WUS structure which can have any of preamble part, sequence part, or data part. Preamble part is generally a known sequence which can be used for synchronization. In some embodiments, the CP handling method depends on the WUS structure. For example, the receiver does not discard CP when detecting the preamble part or sequence part while it discards the CP for the data part.

In another type of embodiment, the CP handling method depends on the WUS duration. For example if the WUS duration is greater than X symbols or greater than Y slots, the receiver discards the CP, otherwise, the receiver does not discard the CP. In another type of embodiment, enabling or disabling a CP handling method is based on the WUS duration. For instance, a CP handling method is applied only if the WUS duration is greater than X symbols or Y slots.

Additional types of embodiments for receiver side CP handling include:
CP handling which depends on the transmitted payload or sequence. For example, some sequences can be known to the receiver, and it tries to find them by performing correlation with local replicas. In this case, CP handling approach can be based on the last bit of the sequence. As discussed above, when the last bit (or segment) is 0, then CP is discarded, otherwise, it is used.
CP handling which depends on the encoding and detection methods. For example, consider the case of Manchester encoding, with bit 1 mapped to [0,1] ([OFF, ON] segments) and bit 0 mapped to [1,0] ([ON, OFF] segments). For decoding, the receiver compares the energy of each two consecutive segments and determines whether they correspond to [0,1] or [1,0] coded bits. Considering such Manchester decoding approach, the CP may be discarded to avoid negative impacts on the detection due to potential noise enhancement. That is, the receiver may discard CP if Manchester coding is used.
CP handling which depends on the OFDM numerology (i.e., subcarrier spacing). As discussed previously, the CP durations for normal symbols and long symbols depend on the subcarrier spacing. Therefore, the CP handling can also depend on the subcarrier spacing. For example, as the subcarrier spacing increases, the CP length for long symbols becomes more comparable with the symbol duration. Therefore, for larger subcarrier spacings handling the CP can be more important. In some embodiments, the CP is discarded if the subcarrier spacing is smaller than a threshold, otherwise, it is used.
   In some embodiments, the CP is handled only for long OFDM symbols.
   In some embodiments, the CP is handled differently for long OFDM symbols and normal OFDM symbols.
CP handling which depends on the receiver architecture and UE capability. For example, for more capable receivers CP is used while for simpler receivers (e.g., with higher clock errors) the CP is discarded.
CP handling in which CP is discarded if the receiver sampling rate is smaller than a threshold. Otherwise, CP is used.
CP handling which depends on coverage condition. For example, in good coverage conditions (e.g., reference signal received power (RSRP) greater than a threshold) CP is discarded as it is less need for enhancing the detection performance. However, in poor coverage condition (e.g., RSRP less than a threshold).
CP handling which depends on the UE battery level. For example, if the battery level is below a threshold CP is discarded to avoid further processing and save power.
Any of the above approaches can be considered in combination with the approach where there is no special handling of the CP, e.g., not discarded or added to the last part of the received signal of an OFDM symbol.

Looking next to transmitter side embodiments, (e.g., gNB), some enhancements can be considered for handling the CP. For example, in one type of embodiment, the CP handling at the transmitter depends on the traffic characteristics and in particular the presence of other non-WUS transmissions. For example, the CP is not included at the transmitter if only WUS is transmitted and other non-WUS signals are not present. This can eliminate the potential issues of CP at the receiver.

In another type of embodiment, depending on the presence of other non-WUS transmissions, zero padding is done instead of CP insertion at the transmitter. This can reduce the impact of CP on the detection performance at the receiver.

In another type of embodiment, the CP is added with a reduced power. For example, the CP power can be 3 dB or 6 dB lower than the transmit power of on OFDM symbol.

In another type of embodiment, the transmitter reduces the impact of CP by adjusting the payload or sequence which needs to be transmitted. For example:
the last OOK segment of all payload or sequences is always set to 0.
the first OOK segment and the last OOK segment are set to be the same.
the first bit and the last bit in an OOK sequence are set to be different, when Manchester coding is applied.

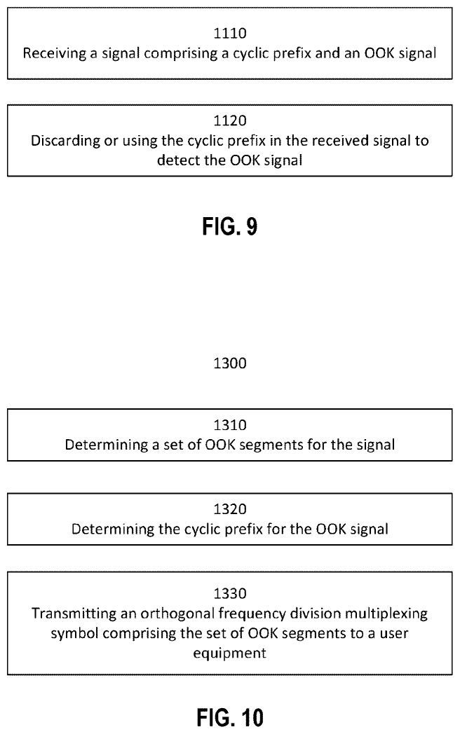

FIG. 9 displays one possible method embodiment under the present disclosure. Method 1100 is a method performed by a user equipment (for example UE QQ112, QQ200) for handling a cyclic prefix for an on-off keying, OOK, signal (for example a wake-up signal) transmitted by an orthogonal frequency-division multiplexing, OFDM, transmitter. Step 1110 is receiving a signal comprising a cyclic prefix and an OOK signal. Step 1120 is discarding or using the cyclic prefix in the received signal to detect the OOK signal. Method 1100 can comprise a variety of additional or alternative steps, such as other steps and embodiments described herein.

In some examples of the method 1100, discarding or using the cyclic prefix comprises discarding or using the cyclic prefix based on one or more factors.

In some examples of the method 1100, discarding or using the cyclic prefix comprises discarding or using the cyclic prefix based on one or more of: a number of OOK segments in the received signal and/or an OOK segment duration in the received signal and/or a data rate of the received signal, a synchronization level and/or a clock error, a user equipment capability and/or receiver architecture, a coverage condition of the user equipment, an OFDM subcarrier spacing and/or OFDM symbol duration, a coding method used for the OOK signal and/or an OOK sequence and/or whether the cyclic prefix corresponds to a 0 bit, and/or whether the cyclic prefix corresponds to a preamble part of the OOK signal, whether the cyclic prefix corresponds to a sequence part of the OOK signal, and/or whether the cyclic prefix corresponds a data part of the OOK signal.

In some examples of the method 1100, discarding the cyclic prefix comprises discarding a first set of samples of the received signal, wherein the first set of samples are from the cyclic prefix.

In some examples of the method 1100, using the cyclic prefix comprises adding a first set of samples to a second set of samples of the received signal, wherein the first set of samples are from the cyclic prefix and the second set of samples are from the OOK signal.

In some examples of the method 1100, the cyclic prefix and OOK signal are transmitted within one OFDM symbol.

In some examples of the method 1100, the signal is transmitted over one or more OFDM symbols and wherein each OFDM symbol of the one or more OFDM symbols comprises a cyclic prefix part and an OOK signal part.

FIG. 10 displays another possible method embodiment under the present disclosure. Method 1300 is a method performed by a network node for handling a cyclic prefix in an OOK signal (for example a wake-up signal). Step 1310 is determining a set of OOK segments for the signal. Step 1320 is determining the cyclic prefix for the OOK signal. Step 1330 is transmitting an orthogonal frequency division multiplexing symbol comprising the set of OOK segments to a user equipment. Method 1300 can comprise a variety of additional or alternative steps, such as other steps and embodiments described herein.

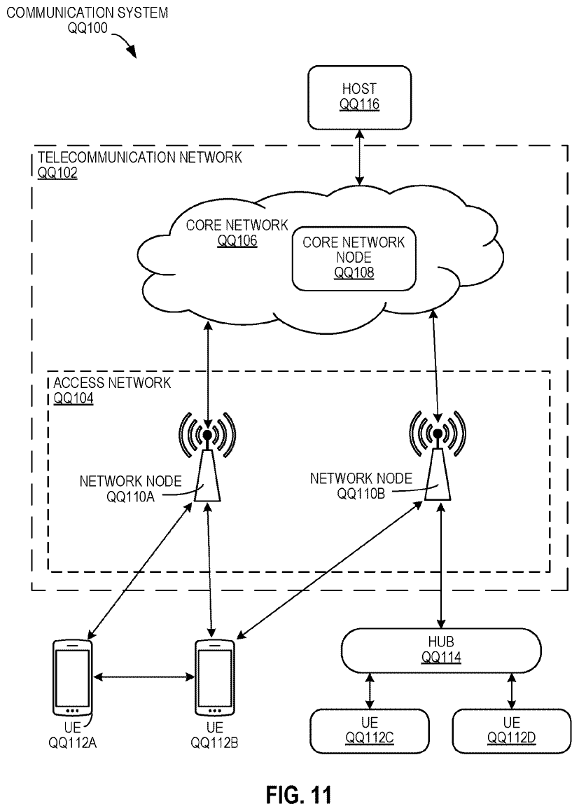

FIG. 11 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

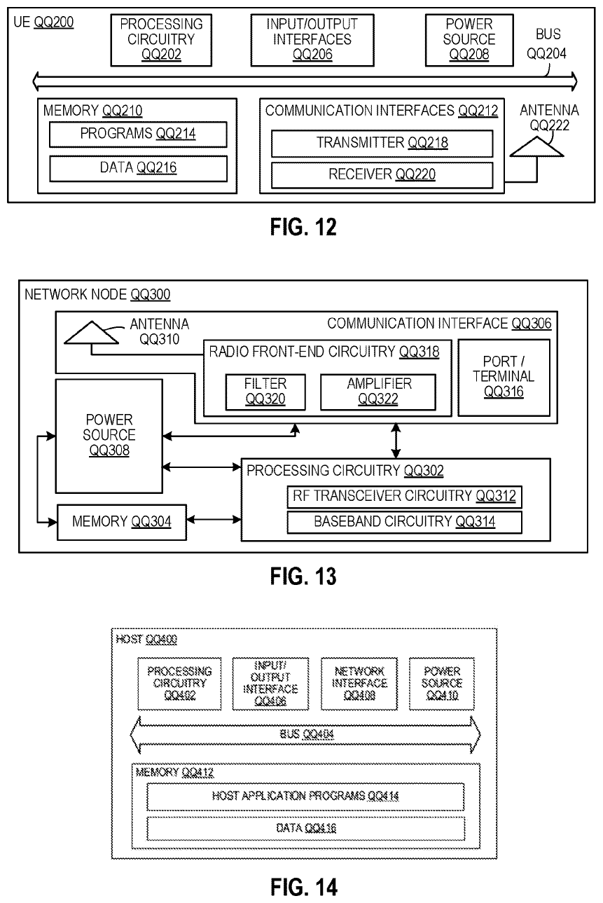

FIG. 12 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project, including a narrow band internet of things UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio, UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency transceiver circuitry QQ312 and baseband processing circuitry QQ314. In some embodiments, the radio frequency transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 13 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

FIG. 14 is a block diagram of a host QQ400, which may be an embodiment of the host QQ116 of FIG. 11, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 12 and 13, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

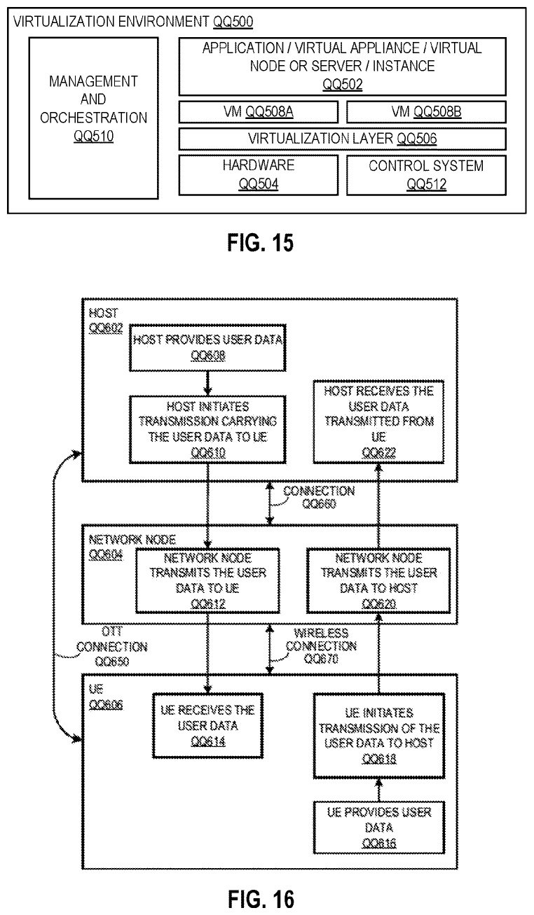

FIG. 15 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

FIG. 16 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 11 and/or UE QQ200 of FIG. 12), network node (such as network node QQ110a of FIG. 11 and/or network node QQ300 of FIG. 13), and host (such as host QQ116 of FIG. 11 and/or host QQ400 of FIG. 14) discussed in the preceding paragraphs will now be described with reference to FIG. 16.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 11) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the power consumption, and thereby provide benefits such as extended battery lifetime.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### NUMBERED EMBODIMENTS

### Group A Embodiments

1. A method performed by a user equipment for handling a cyclic prefix in a wake-up signal, the method comprising:
receiving, at a first radio comprised by the user equipment, the wake-up signal;
identifying the cyclic prefix and a set of wake-up segments in the wake-up signal; and
based on the set of wake-up segments, waking up a second radio, wherein the second radio is comprised by the user equipment and the user equipment is configured to use the second radio for data transmission.

2. The method of embodiment 1, further comprising the step of:
discarding the cyclic prefix.

3. The method of embodiment 1, further comprising the step of:
using the cyclic prefix by, for each of a first plurality of samples in the wake-up signal, adding a sample from a second plurality of samples to that sample from the first plurality of samples, wherein the second plurality of samples is samples corresponding to the cyclic prefix, and wherein the first plurality of samples are samples not corresponding to the cyclic prefix.

4. The method of embodiment 3, wherein the second plurality of samples comprises less than all samples corresponding to the cyclic prefix.

5. The method of any of the previous embodiments, further comprising the step of:
determining whether to discard or use the cyclic prefix based on whether a timing error exceeds a first threshold.

6. The method of embodiment 5, further comprising the step of:
determining a manner for using the cyclic prefix based on whether the timing error exceeds a second threshold.

7. The method of embodiment 6, wherein determining the manner for using the cyclic prefix based on whether the timing error exceeds the second threshold comprises determining whether to use less than all samples corresponding to the cyclic prefix based on whether the timing error exceeds the second threshold.

8. The method of any of the previous embodiments, further comprising the step of:
determining whether to discard or use the cyclic prefix based on whether the cyclic prefix corresponds to a 0 bit.

9. The method of any of the previous embodiments, further comprising the step of:
determining whether to discard or use the cyclic prefix based on whether a length of the set of wake-up segments exceeds a threshold.

10. The method of any of embodiments 1-9, further comprising the steps of:
obtaining a first result by performing detection using a first method of handling the cyclic prefix; and
obtaining a second result by performing detection using a second method of handling the cyclic prefix

11. The method of embodiment 10, further comprising the steps of:
performing a confidence comparison, wherein confidence comparison comprises comparing a confidence of the first result and a confidence of the second result; and
determining an interpreted result based on the confidence comparison.

12. The method of embodiment 10, further comprising the step of:
determining an interpreted result as an average of the first result and the second result.

13. The method of any of the previous embodiments, further comprising the step of:
determining whether the discard or use the cyclic prefix based on whether the cyclic prefix corresponds to a preamble part of the wake-up signal, whether the cyclic prefix corresponds to a sequence part of the wake-up signa, or whether the cyclic prefix corresponds a data part of the wake-up signal.

14. The method of any of the previous embodiments, further comprising the step of:
determining whether to discard or use the cyclic prefix based on a duration of the wake-up signal.

15. The method of any of the previous embodiments, further comprising the step of:
determining a method of any of the previous embodiments using the cyclic prefix based on a duration of the wake-up signal.

16. The method of any of the previous embodiments, further comprising the step of:
determining whether to discard or use the cyclic prefix based on a coding method used for the wake-up signal.

17. The method of any of the previous embodiments, further comprising the step of:
determining whether to discard or use the cyclic prefix based on a coverage condition of the user equipment.

18. The method of any of the previous embodiments, further comprising the step of:
determining whether to discard or use the cyclic prefix based on a batter level of the user equipment.

19. The method of any of the previous embodiments, further comprising:
providing user data; and
forwarding the user data to a host via the transmission to the network node.

### Group B Embodiments

20. A method performed by a network node for handling a cyclic prefix in a wake-up signal, the method comprising:
determining a set of wake-up segments for the wake-up signal;
determining the cyclic prefix for the wake-up signal;
transmitting an orthogonal frequency division multiplexing symbol comprising the set of wake-up segments to a user equipment.

21. The method of embodiment 20, wherein:
transmitting the orthogonal frequency division multiplexing signal comprises transmitting the cyclic prefix at a first power, and transmitting the wake-up segments at a second power, wherein the first power is less than the second power.

22. The method of embodiment 20, wherein:
determining the set of wake-up segments for the wake-up signal comprises confirming that a last wake-up segment is set to 0.

23. The method of embodiment 20, wherein:
determining the set of wake-up segments for the wake-up signal comprises confirming that a first wake up segment and a last wake up segment are the same.

24. The method of embodiment 20, wherein:
Manchester coding is applied to transmitting the orthogonal frequency division multiplexing symbol; and
determining the set of wake-up segments for the wake-up signal comprises confirming that a first wake-up segment and a last wake-up segment are different.

25. The method of embodiment 20, wherein:
determining the cyclic prefix for the wake-up signal comprises determining whether to omit the cyclic prefix when transmitting the orthogonal frequency division multiplexing symbol.

26. The method of embodiment 25, wherein:
transmitting the orthogonal frequency division multiplexing symbol comprises transmitting the orthogonal frequency division multiplexing symbol with zero padding and not transmitting the cyclic prefix.

27. The method of any of embodiments 25-26, wherein:
determining the cyclic prefix for the wake-up signal comprises determining whether to omit the cyclic prefix when transmitting the orthogonal frequency division multiplexing symbol based on traffic characteristics.

28. The method of embodiment 27, wherein:
determining whether to omit the cyclic prefix when transmitting the orthogonal frequency division multiplexing symbol based on traffic characteristics comprises determining whether to omit the cyclic prefix when transmitting the orthogonal frequency division multiplexing symbol based on presence of non-wake-up signal transmissions.

29. The method of any of the previous embodiments, further comprising:
obtaining user data; and forwarding the user data to a host or a user equipment.

### Group C Embodiments

30. A user equipment for handling a cyclic prefix in a wake-up signal, comprising:
processing circuitry configured to perform any of the steps of any of the Group A embodiments; and
power supply circuitry configured to supply power to the processing circuitry.

31. A network node for handling a cyclic prefix in a wake-up signal, the network node comprising:
processing circuitry configured to perform any of the steps of any of the Group B embodiments;
power supply circuitry configured to supply power to the processing circuitry.

32. A user equipment (UE) for handling a cyclic prefix in a wake-up signal, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

33. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to receive the user data from the host.

34. The host of the previous embodiment, wherein the cellular network further includes a network node configured to communicate with the UE to transmit the user data to the UE from the host.

35. The host of the previous 2 embodiments, wherein:
the processing circuitry of the host is configured to execute a host application, thereby providing the user data; and
the host application is configured to interact with a client application executing on the UE, the client application being associated with the host application.

36. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.

37. The method of the previous embodiment, further comprising:
at the host, executing a host application associated with a client application executing on the UE to receive the user data from the UE.

38. The method of the previous embodiment, further comprising:
at the host, transmitting input data to the client application executing on the UE, the input data being provided by executing the host application,
wherein the user data is provided by the client application in response to the input data from the host application.

39. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.

40. The host of the previous embodiment, wherein the cellular network further includes a network node configured to communicate with the UE to transmit the user data from the UE to the host.

41. The host of the previous 2 embodiments, wherein:
the processing circuitry of the host is configured to execute a host application, thereby providing the user data; and
the host application is configured to interact with a client application executing on the UE, the client application being associated with the host application.

42. A method implemented by a host configured to operate in a communication system that further includes a network node and a user equipment (UE), the method comprising:
at the host, receiving user data transmitted to the host via the network node by the UE, wherein the UE performs any of the steps of any of the Group A embodiments to transmit the user data to the host.

43. The method of the previous embodiment, further comprising:

at the host, executing a host application associated with a client application executing on the UE to receive the user data from the UE.

44. The method of the previous embodiment, further comprising:
at the host, transmitting input data to the client application executing on the UE, the input data being provided by executing the host application,
wherein the user data is provided by the client application in response to the input data from the host application.

45. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

46. The host of the previous embodiment, wherein:
the processing circuitry of the host is configured to execute a host application that provides the user data; and
the UE comprises processing circuitry configured to execute a client application associated with the host application to receive the transmission of user data from the host.

47. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

48 The method of the previous embodiment, further comprising, at the network node, transmitting the user data provided by the host for the UE.

49. The method of any of the previous 2 embodiments, wherein the user data is provided at the host by executing a host application that interacts with a client application executing on the UE, the client application being associated with the host application.

50. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

51. The communication system of the previous embodiment, further comprising:
the network node; and/or
the user equipment.

52. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

53. The host of the previous 2 embodiments, wherein:
the processing circuitry of the host is configured to execute a host application, thereby providing the user data; and
the host application is configured to interact with a client application executing on the UE, the client application being associated with the host application.

54. The host of the any of the previous 2 embodiments, wherein the initiating receipt of the user data comprises requesting the user data.

55. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.

55. The method of the previous embodiment, further comprising at the network node, transmitting the received user data to the host.

1. A method performed by a user equipment for handling a cyclic prefix for an on-off keying, OOK, signal transmitted by an orthogonal frequency-division multiplexing, OFDM, transmitter, the method comprising:
receiving a signal comprising a cyclic prefix and an OOK signal; and
discarding or using the cyclic prefix in the received signal to detect the OOK signal.

2. The method of claim 1, wherein discarding or using the cyclic prefix comprises discarding or using the cyclic prefix based on one or more factors.

3. The method of claim 1, wherein discarding or using the cyclic prefix comprises discarding or using the cyclic prefix based on one or more of:
a number of OOK segments in the received signal and/or an OOK segment duration in the received signal and/or a data rate of the received signal,
a synchronization level and/or a clock error,
a user equipment capability and/or receiver architecture,
a coverage condition of the user equipment,
an OFDM subcarrier spacing and/or OFDM symbol duration,
a coding method used for the OOK signal and/or an OOK sequence and/or whether the cyclic prefix corresponds to a 0 bit, and/or
whether the cyclic prefix corresponds to a preamble part of the OOK signal, whether the cyclic prefix corresponds to a sequence part of the OOK signal, and/or whether the cyclic prefix corresponds a data part of the OOK signal.

4. The method of claim 1, wherein discarding the cyclic prefix comprises discarding a first set of samples of the received signal, wherein the first set of samples are from the cyclic prefix.

5. The method of claim 1, wherein using the cyclic prefix comprises adding a first set of samples to a second set of samples of the received signal, wherein the first set of samples are from the cyclic prefix and the second set of samples are from the OOK signal.

6. The method of claim 1, wherein the cyclic prefix and OOK signal are transmitted within one OFDM symbol.

7. The method of claim 1, wherein the signal is transmitted over one or more OFDM symbols and wherein each OFDM symbol of the one or more OFDM symbols comprises a cyclic prefix part and an OOK signal part.

8. A user equipment for handling a cyclic prefix for an on-off keying, OOK, signal transmitted by an OFDM transmitter, the user equipment configured to:
receive a signal comprising a cyclic prefix and an OOK signal; and
discard or use the cyclic prefix in the received signal to detect the OOK signal.

9. The user equipment of claim 8, wherein discarding or using the cyclic prefix comprises discarding or using the cyclic prefix based on one or more factors.

10. The user equipment of claim 8, wherein discarding or using the cyclic prefix comprises discarding or using the cyclic prefix based on one or more of:
a number of OOK segments in the received signal and/or an OOK segment duration in the received signal and/or a data rate of the received signal,
a synchronization level and/or a clock error,
a user equipment capability and/or receiver architecture,
a coverage condition of the user equipment,
an OFDM subcarrier spacing and/or OFDM symbol duration,
a coding method used for the OOK signal and/or an OOK sequence and/or whether the cyclic prefix corresponds to a 0 bit, and/or
whether the cyclic prefix corresponds to a preamble part of the OOK signal, whether the cyclic prefix corresponds to a sequence part of the OOK signal, and/or whether the cyclic prefix corresponds a data part of the OOK signal.

11. The user equipment of claim 8, wherein discarding the cyclic prefix comprises discarding a first set of samples of the received signal, wherein the first set of samples are from the cyclic prefix.

12. The user equipment of claim 8, wherein using the cyclic prefix comprises adding a first set of samples to a second set of samples of the received signal, wherein the first set of samples are from the cyclic prefix and the second set of samples are from the OOK signal.

13. The user equipment of claim 8, wherein the cyclic prefix and OOK signal are transmitted within one OFDM symbol.

14. The user equipment of claim 8, wherein the signal is transmitted over one or more OFDM symbols and wherein each OFDM symbol of the one or more OFDM symbols comprises a cyclic prefix part and an OOK signal part.
